(19) United States
(12) Patent Application Publication
(10) Pub. No.: US 2026/0130326 A1
(43) Pub. Date: May 14, 2026

(54) FLEXIBLE PLANT PROTECTION DEVICE

(71) Applicant: Shape and Shades, LLC, Denver, CO (US)

(72) Inventors: Stephanie Lynn Young, Denver, CO (US); Adam Joseph Zimmer, Morrison, CO (US); Jordan Alexander Via, Westminster, CO (US); Kian Cedric Roybal, Denver, CO (US)

(21) Appl. No.: 18/941,346

(22) Filed: Nov. 8, 2024

(51) Int. Cl. A01G 13/02

(52) U.S. Cl. CPC A01G 13/21

(57) ABSTRACT

A plant protection device having a shade configured to limit environmental exposure and a flexible pole attached to the shade. The flexible pole terminates in a tip configured for insertion into soil. The flexible pole is made of a material that allows the pole to be bent and retain its shape, enabling customizable positioning of the. The device may have a base with a flange and holes to accommodate multiple flexible poles.

### FIELD OF INVENTION

The present disclosure relates to plant protection devices, and more particularly to a flexible plant protection device with an adjustable shade for shielding plants from environmental elements.

### BACKGROUND

Plant protection devices have long been used by gardeners and horticulturists to shield plants from harsh environmental conditions. These devices typically aim to protect plants from excessive sunlight, heavy rain, hail, or other potentially damaging elements. Traditional plant protection methods often involve static structures like greenhouses, cold frames, or simple covers that provide a fixed barrier between plants and the environment.

While effective in many situations, conventional plant protection devices can be limiting in their ability to adapt to changing environmental conditions or the specific needs of individual plants. Fixed structures may not allow for easy adjustment of light exposure or airflow, which can be crucial for optimal plant growth and health. Additionally, many existing devices are designed for larger-scale applications and may not be suitable for individual plants or small garden spaces.

The materials used in traditional plant protection devices can also present challenges. Rigid plastics or glass used in greenhouses and cold frames, while durable, lack the flexibility to accommodate the natural movement of plants or to be easily repositioned. Fabric covers, while more flexible, may not provide adequate protection against all environmental threats and can be prone to tearing or degradation over time.

Furthermore, the installation and removal of many plant protection devices can be cumbersome, often requiring significant time and effort. This can discourage gardeners from using protection when needed or from making frequent adjustments to optimize growing conditions. There is a need for plant protection solutions that offer greater flexibility, ease of use, and adaptability to various plant types and environmental conditions.

As interest in home gardening and small-scale agriculture continues to grow, there is an increasing demand for innovative plant protection solutions that can meet the diverse needs of individual plants while being user-friendly and aesthetically pleasing. Gardeners and plant enthusiasts are seeking devices that not only protect their plants but also enhance the overall appearance of their gardens or living spaces.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a plant protection device is provided. The plant protection device includes a shade configured to limit environmental exposure. The device also includes a flexible pole attached to the shade and terminating in a tip configured for insertion into soil, wherein the flexible pole is made of a material that allows the pole to be bent and retain its shape.

According to other aspects of the present disclosure, the device may include one or more of the following features. The flexible pole may be made of annealed aluminum. The shade may be attached to the flexible pole via one or more U-shaped couplers. The shade may comprise coupler slots through which the U-shaped couplers pass to wrap around the flexible pole. The U-shaped couplers may be made of a material different from the shade and flexible pole. The U-shaped couplers may be made of steel. The shade may be attached to the flexible pole via one or more welds of metal or plastic. The shade may be attached to the flexible pole via two or more separate welds. The flexible pole may be attached to the center of the shade. The flexible pole may be a solid rod. The device may further comprise a base with a flange to resist torsional forces and also having one or more holes with a vertical axis, wherein the tip of the flexible pole is configured to be inserted through one of the holes. The base may comprise multiple holes to accommodate multiple flexible poles. The base may comprise holes of at least two different diameters to accommodate flexible poles of different sizes. The shade may comprise one or more cutouts to allow partial light and water passage. The shade may be made of thin aluminum. Both the shade and the flexible pole may be made of aluminum, allowing both components to be flexible. The flexible pole may be permanently attached to the shade. The tip of the flexible pole may terminate as the pole only, without additional components, to allow direct insertion into soil. The shade may be made of thin sheet material. The shade may be permanently attached to the pole to improve strength and ease of manufacturing.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a perspective view of a plant protection device, according to aspects of the present disclosure.

FIG. 2 illustrates an isometric view of the plant protection device of FIG. 1, according to an embodiment.

FIG. 3 illustrates a perspective view of a base for a plant protection device, according to aspects of the present disclosure.

FIG. 4 illustrates a perspective view of the plant protection device having multiple shades with multiple plants, according to an embodiment.

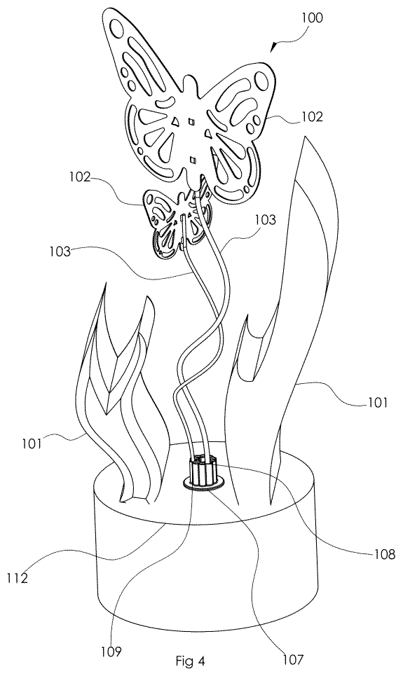

FIG. 5 illustrates a perspective view of the plant protection device of FIG. 1, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to plant 101 protection devices. In particular, the disclosure provides a flexible plant protection device 100 that may be easily adjusted to shield plants from various environmental elements. The plant protection device 100 may include a shade 102 component and a flexible pole 103 component. The shade 102 component may be configured to limit environmental exposure to a plant 101. The flexible pole 103 component may be attached to the shade 102 component and may terminate in a tip 110. The tip 110 may be configured for insertion into soil 112. The flexible pole 103 may be composed of a material that allows the pole to be bent and retain its shape. This configuration may allow a user to adjust the position of the shade 102 component relative to a plant 101. The plant protection device 100 may be customized to accommodate plants of different sizes and shapes. The flexible nature of the pole may allow for repositioning of the shade 102 as needed to provide optimal protection from sun, wind, rain, or other environmental factors. The shade 102 component may be made from various materials and may include features such as cutouts 104 to allow partial light and water passage. In some aspects, the plant protection device 100 may include additional components such as a base 107 with multiple holes to accommodate one or more flexible poles. The plant protection device 100 may offer advantages in terms of adaptability, ease of use, and effectiveness in protecting individual plants or small groups of plants in various settings.

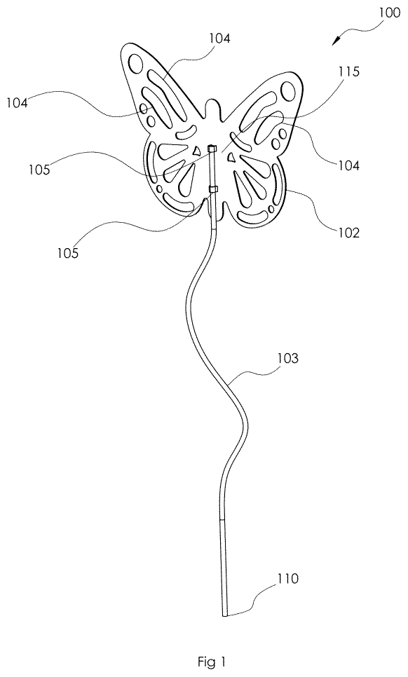

Referring to FIG. 1, a plant protection device 100 may comprise a shade 102 and a flexible pole 103. The shade 102 may be configured to limit environmental exposure to a plant 101. In some aspects, the shade 102 may have a decorative shape, such as a butterfly shape as shown in FIG. 1. The flexible pole 103 may be attached to the shade 102 and may terminate in a tip 110. The tip 110 may be configured for insertion into soil 112, allowing the plant protection device 100 to be securely positioned near a plant 101.

The flexible pole 103 may be made of a material that allows the pole to be bent and retain its shape. This characteristic may enable users to adjust the position of the shade 102 relative to a plant 101, providing customized protection based on the plant's size, shape, and environmental conditions. In some cases, the flexible pole 103 may be made of annealed aluminum, which offers both flexibility through high ductility and shape retention properties.

The shade 102 may comprise one or more cutouts 104. These cutouts 104 may allow partial light and water passage through the shade 102. The size, shape, and arrangement of the cutouts 104 may vary depending on the specific requirements of the plant 101 being protected. In some aspects, the cutouts 104 may be designed to create an aesthetically pleasing pattern on the shade 102, such as the wing-like patterns shown in FIG. 1.

The attachment between the shade 102 and the flexible pole 103 may be achieved through various means. In some cases, as illustrated in FIG. 1, U-shaped couplers 105 may be used to secure the shade 102 to the flexible pole 103. These U-shaped couplers 105 may wrap around the flexible pole 103 and pass through corresponding slots in the shade 102.

The plant protection device 100 may be designed to accommodate plants of various sizes. The flexibility of the pole 103 may allow users to adjust the height inserting the pole into the soil 112 at different depths and also provide an angle of the shade 102 as needed by flexing the pole by hand. This adaptability may make the plant protection device 100 suitable for use with a wide range of plants, from small seedlings to larger established plants.

Referring to FIG. 1, the flexible pole 103 may terminate in a tip 110 that is configured for direct insertion into soil 112. In some aspects, the tip 110 may be formed as an integral part of the flexible pole 103, without additional components. This design may allow for easy and secure placement of the plant protection device 100 in various soil 112 types. The seamless transition from the flexible pole 103 to the tip 110 allows it to be easily inserted into the ground.

The shade 102 may be made of a material that allows for further shaping to provide enhanced protection. In some cases, the shade 102 may be made of thin aluminum or another malleable material. This characteristic may enable users to manually adjust the curvature or angle of the shade 102 to better suit the specific needs of the plant 101 being protected. For example, the edges of the shade 102 may be bent slightly downward to create a more enclosed protective environment, or shaped to direct water runoff away from delicate plant 101 structures. In other cases, the shade 102 may be made of a thin sheet material such as plastic which can't be deformed but provides a lightweight shade 102 that won't cause the flexible pole 103 to deform due to the force of gravity.

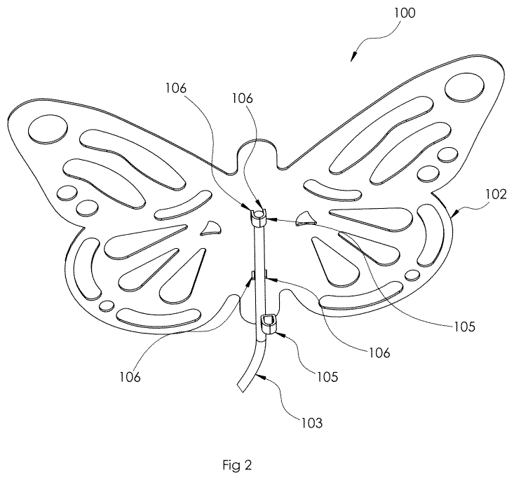

Referring to FIG. 2, the plant protection device 100 may include a mechanism for attaching the shade 102 to the flexible pole 103. In some aspects, this attachment may be achieved through the use of one or more U-shaped couplers 105. The shade 102 may comprise coupler slots 106 strategically positioned to accommodate these U-shaped couplers 105. The coupler slots 106 may match the shape of the U-shaped couplers 105 so that they do not gaps which distract from the aesthetic of the design.

The U-shaped couplers 105 may be designed to pass through the coupler slots 106 in the shade 102 and wrap around the flexible pole 103. This configuration may allow for a secure connection between the shade 102 and the flexible pole 103 while still permitting some degree of adjustability. In some cases, the U-shaped couplers 105 may be crimped or otherwise tightened around the flexible pole 103 to ensure a firm grip.

The number and placement of the coupler slots 106 on the shade 102 may vary depending on the specific design requirements. For example, in the butterfly-shaped shade 102 shown in FIG. 2, the coupler slots 106 may be positioned near the center 115 of the shade 102, corresponding to the “body” of the butterfly design. This placement may provide balanced support for the shade 102 while maintaining the aesthetic appeal of the design.

In some aspects, the U-shaped couplers 105 may be made of a material different from that of the shade 102 and flexible pole 103. For instance, the U-shaped couplers 105 may be constructed from a more rigid or durable material to enhance the strength of the attachment. In some cases, the U-shaped couplers 105 may be made of steel or another metal alloy that resists deformation.

To further increase the strength and durability of the attachment, the U-shaped couplers 105 may be welded along their seams in some implementations. This welding process may create a more robust connection between the shade 102 and the flexible pole 103, potentially increasing the longevity of the plant protection device 100 and its ability to withstand various environmental conditions.

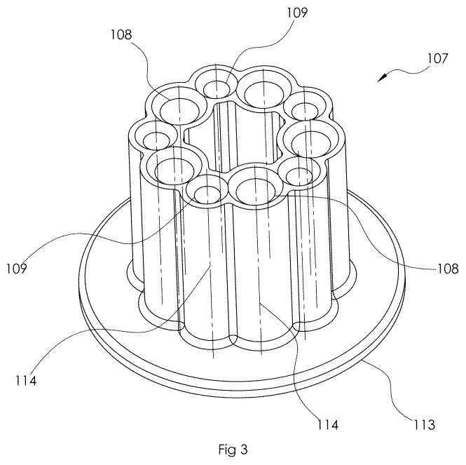

Referring to FIG. 3, the plant protection device 100 may include a base 107 designed to provide stability and versatility. In some aspects, the base 107 may comprise a flange 113 extending outward from its bottom edge. The flange 113 may be configured to resist torsional forces when the base 107 is placed on soil 112 or another surface. This design feature may enhance the overall stability of the plant protection device 100, particularly in windy conditions or when supporting multiple flexible poles.

The base 107 may include one or more holes with a diameter 108 arranged in a pattern, such as a circular arrangement around the perimeter of the platform. Each of these holes 108 may have a vertical axis 114, ensuring that flexible poles inserted into the holes 108 are oriented perpendicular to the base 107. This vertical orientation may allow for proper positioning of attached shades or other protective elements.

In some cases, the base 107 may comprise multiple holes 108 to accommodate multiple flexible poles. This configuration may enable users to set up several plant 101 protection devices simultaneously, providing coverage for multiple plants or creating more complex shading arrangements. The ability to use multiple poles with a single base 107 may offer increased flexibility in garden design and plant 101 protection strategies. The vertical orientation of the holes makes it so the multiple flexible poles 103 do not converge or diverge making it so it can be easily stuck into the soil 112.

Additionally, the base 107 may include holes with different diameters to accommodate flexible poles of various sizes. For example, as shown in FIG. 3, the base 107 may feature a hole with another diameter 109 located in the center 115 of the circular arrangement of holes 108. This variation in hole sizes may allow users to combine different types or sizes of plant 101 protection devices within a single base 107, further enhancing the system's adaptability to diverse plant 101 protection needs.

The structure of the base 107, with its multiple holes 108 and 109 of different diameters, may provide users with the flexibility to create customized configurations of plant 101 protection devices. This versatility may be particularly useful in situations where plants of varying sizes or with different sun exposure requirements are grouped together. The base 107 design may allow gardeners to easily adjust and rearrange their plant 101 protection setup as needed, adapting to changing plant 101 growth patterns or seasonal variations in sunlight.

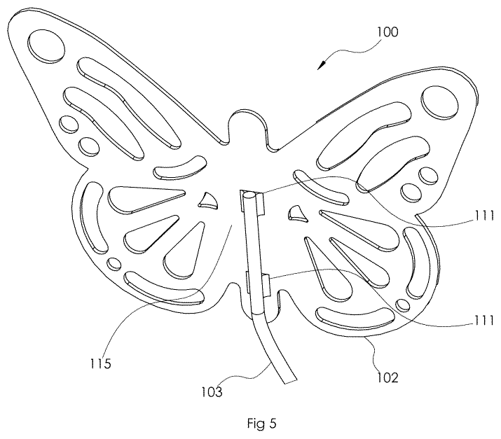

Referring to FIG. 5, a prospective view of the plant protection device 100 may be observed. The attachment between the shade 102 and the flexible pole 103 may be achieved through various means. In some cases, as illustrated in FIG. 5, one or more welds 111 may be used to secure the shade 102 to the flexible pole 103. These welds 111 may be made of metal or plastic, depending on the materials used for the shade 102 and flexible pole 103. In the example shown, two welds 111 are depicted, one on each side of the center 115. This configuration may provide a permanent and stable attachment between the shade 102 and the flexible pole 103.

The placement of the flexible pole 103 at the center 115 of the shade 102 may offer several advantages. In some aspects, this central attachment point may provide balanced support for the shade 102, potentially improving the overall stability of the plant protection device 100. Additionally, the central positioning may allow for more uniform distribution of environmental protection around the plant 101.

The flexible pole 103 may be composed of various materials that enable flexibility, durability, and adaptability to different plant 101 protection needs. In some aspects, the flexible pole 103 may be made of annealed aluminum. Annealed aluminum may provide a desirable combination of flexibility and shape retention, allowing users to bend the pole 103 into a desired position and have it maintain that shape. The annealing process may enhance the aluminum's ductility, making it less prone to work hardening or breaking when repeatedly flexed.

In some cases, the flexible pole 103 may be a solid rod. A solid rod construction may offer increased strength and stability compared to hollow designs, potentially improving the overall durability of the plant protection device 100. The solid rod design may also help prevent kinking or collapsing when the pole 103 is bent into various shapes, as would happen with a hollow tube.

To accommodate different plant 101 sizes and protection needs, the flexible pole 103 may be available in various diameters. Smaller diameter poles may be suitable for delicate plants or situations requiring minimal shading, while larger diameter poles may provide increased stability for heavier shades or in more demanding environmental conditions.

The shade 102 may be constructed from thin aluminum in some aspects. Thin aluminum may offer a balance of lightweight properties and durability, potentially enhancing the overall portability and longevity of the plant protection device 100. The use of thin aluminum for the shade 102 may also allow for some degree of flexibility, enabling users to make minor adjustments to the shape of the shade 102 to better suit specific plant 101 protection needs.

The shade 102 and flexible pole 103 of the plant protection device 100 may be constructed from various materials to provide desired properties of flexibility, durability, and compatibility. In some aspects, both the shade 102 and the flexible pole 103 may be made of aluminum, allowing both components to be flexible. The use of aluminum for both elements may provide a lightweight yet sturdy construction that can be easily manipulated to accommodate different plant 101 protection needs.

The shade 102 may be made of thin sheet material in some cases. This thin construction may allow for easy shaping and positioning of the shade 102 while still providing effective protection for plants. In some aspects, the shade 102 may be made of plastics or wood, offering alternative material options that may suit different environmental conditions or aesthetic preferences.

The U-shaped couplers 105 used to attach the shade 102 to the flexible pole 103 may be made of a material different from the shade 102 and flexible pole 103. This difference in materials may provide enhanced strength and durability at the connection points. In some cases, the U-shaped couplers 105 may be made of steel, offering superior rigidity and resistance to deformation compared to the more flexible aluminum components.

A number of implementations have been described. Nevertheless, it will be understood that various modifications may be made without departing from the spirit and scope of the disclosure. Accordingly, other implementations are within the scope of the following claims.

1. A plant protection device, comprising:
a shade configured to limit environmental exposure;
a flexible pole attached to the shade and terminating in a tip configured for insertion into soil, wherein the flexible pole is made of a material that allows the pole to be repeatedly bent and retain its shape in a new position, and the shade is made of a single layer of thin sheet material.

2. The plant protection device of claim 1, wherein the flexible pole is made of annealed aluminum.

3. The plant protection device of claim 1, wherein the shade is attached to the flexible pole via one or more U-shaped couplers.

4. The plant protection device of claim 3, wherein the shade comprises coupler slots through which the U-shaped couplers pass to wrap around the flexible pole.

5. The plant protection device of claim 3, wherein the U-shaped couplers are made of a material different from the shade and flexible pole.

6. The plant protection device of claim 5, wherein the U-shaped couplers are made of steel.

7. The plant protection device of claim 1, wherein the shade is attached to the flexible pole via one or more welds of metal or plastic.

8. The plant protection device of claim 7, wherein the shade is attached to the flexible pole via two or more separate welds.

9. The plant protection device of claim 1, wherein the flexible pole is attached near a center of the shade.

10. The plant protection device of claim 2, wherein the flexible pole is a solid rod.

11. The plant protection device of claim 1, further comprising a base with a flange and also having one or more holes with a vertical axis, wherein the tip of the flexible pole is configured to be inserted through one of the holes.

12. The plant protection device of claim 11, wherein the base comprises multiple holes to accommodate multiple flexible poles.

13. The plant protection device of claim 12, wherein the base comprises holes of at least two different diameters to accommodate flexible poles of different sizes.

14. The plant protection device of claim 1, wherein the shade comprises one or more cutouts to allow partial light and water passage.

15. The plant protection device of claim 1, wherein the shade consists of thin aluminum sheet with a plurality of cutouts to allow partial light and water passage.

16. The plant protection device of claim 15, wherein both the shade and the flexible pole are made of aluminum, allowing both components to be flexible and repositionable.

17. The plant protection device of claim 1, wherein the flexible pole is permanently attached to the shade.

18. The plant protection device of claim 1, wherein the tip of the flexible pole terminates as the pole only, without additional components, to allow direct insertion into soil.

19. The plant protection device of claim 1, wherein the thin sheet material consists of metal or plastic.

20. The plant protection device of claim 1, wherein the shade is permanently attached to the pole to improve strength and ease of manufacturing.
